(19) United States
(12) Patent Application Publication
(10) Pub. No.: US 2006/0123945 A1
(43) Pub. Date: Jun. 15, 2006

(54) Continuously adjustable gear system

(76) Inventor: Herwig Fischer, Poznan (PL)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/541,865

(22) PCT Filed: Dec. 19, 2003
(86) PCT No.: PCT/EP03/14628

§ 371 Date: Jul. 8, 2005

(30) Foreign Application Priority Data
Jan. 16, 2003 (DE) 103 01 348.2

(51) Int. Cl. F16H 3/02

(52) U.S. Cl. 74/745

(57) ABSTRACT

The invention relates to a gear system. The further development of said gear system is characterized in that the geometry of the coupling elements (13), the peripheral groove and the positive locking elements (12) of the annular disk (10), together with that of the guides of the star-shaped disk and the distance between the annular disk (10) to the star-shaped disk is selected in such a way that the forces occurring when the charge arc as it passes between the coupling element (13) and the star-shaped disk result in the production of a positive-locking contact or reinforce said contact, whereby the pressing force produces a moment which holds the coupling element (13) in a plane-parallel position with respect to the annular disk (10) and the star-shaped disk, said moment being greater than the tilting moment which is determined by the distance between the active plane on which force is transmitted from the annular disk (10) to the coupling elements (13) and the active plane on which force is transmitted from the coupling elements (13) to the star-shaped disk.

The invention relates to a stepless transmission with a ring having a force-transmitting formation, preferably with teeth, and a peripheral groove, and concentrically or eccentrically positionable relative thereto a center wheel with radial guides, and with at least two coupling elements that each ride at one end in the peripheral groove and that have force-transmitting formations complementary to the force-transmitting formation and that each at the other end have a force-transmitting pin projecting axially into and shiftable in a respective one of the radial guides of the center wheel, each coupling element moving on orbiting in the peripheral groove of the gear through a force-transmitting zone in which the coupling element is engaged with the force-transmitting formations of the gear and that otherwise is in a free-running zone in which it is disconnected (decoupled) and where by varying the eccentricity of the center wheel and ring the transmission ratio is changeable.

Such a transmission is for example described in German 199 53 643.

According to EP 0,708,896 a stepless or nearly stepless transmission is known having a driving and a drive member and several individual gears that together form a satellite assembly that is in constant force-transmitting connection with a central gear. If the relationship of the effective radius of the satellite assembly and the central wheel and the eccentric position of the satellite assembly and the central gear are varied relative to each other by appropriate means, the transmission ratio between the driving and the driven member is correspondingly varied. The gears forming the satellite assembly orbit cyclically when the central gear is eccentric through a force-transmitting zone and a free-running zone, the gears being arranged to orbit about the satellite-assembly axis and to rotate via respective unidirectional clutches about their own axes. On moving from the free-running zone to the force-transmitting zone the gears enter into force-transmitting engagement by blocking fo their rotation for torque transmission. There is some variation in the transmission of torqued caused by the variation in the radius as the force-transmitting zone is traversed and/or the effective tangential component is partly compensated by cyclical control. In one concrete embodiment that is described in this publication, the coupling elements are carried on the rim of the driving member and can move along radial grooves in the driven member. The coupling elements are interconnected by different direction sensitive force and/or shape effects so that at any time that coupling element is effective to transmit torque that leads to the highest angular speed in the driven member.

In EP 1,003,984 there is another such transmission with satellite or wedge elements that is comprised of a one- or multi-part base and a one- or multi-part contact body that in a force-transmitting position locks in the guide of the drive member, projecting wedge-body pins or an element connected to the wedge body having two parts, normally axially offset, fitted in radial guides of the driven member. The wedge elements can according to another embodiment be formed by contact bodies of nonround section, one surface portion of the contact body having a radius of curvature generally the same as the radius of curvature of the annular groove wall of the ring with which this surface portion forms a friction connection in the force-transmitting position, so that Hertz pressure is minimized, the relationship of the radii being between 0.6 and 1.4.

It is critical for the operation of these transmission that the operation of the satellite or coupling elements be compact, fast, and accurate. The goal of fast-acting coupling and decoupling action is analogous to that of free-running clutches, but they are different from the transmission discussed here. Free-running clutches always have quite a few coupling elements that can engage and disengage at any position, with wedge-body transmissions (so-called satellite transmissions) the coupling and uncoupling always take place at specific locations, that is when the force-transmitting zone is entered, so that at any time only one coupling element is engaged and the remaining coupling elements are moving through their free-running zones. With satellite transmissions it is also highly important that the coupling elements which each must all alone transmit force from the ring serving as drive body to the center wheel serving as driven body, while with free-running clutches the force transmission takes place between inner and outer rings between which the wedge bodies rotate and normally via all the wedge bodies. In transmission the number of couplings and the force transmission via a single coupling element is normally also higher.

It is thus an object of the present invention so to improve the described stepless transmission that the transmission is simple and sure in operation.

This object is achieved by the transmission according to claim 1.

The steplessly variable transmission according to the invention has a ring with a peripheral groove and force-transmitting formations that preferably are formed as an annular row of teeth. This peripheral groove serves as a guide for coupling elements having force-transmitting formations, e.g. teeth, complementary to the force-transmitting formation of the ring and serving for transmitting force to the teeth of the ring. These coupling elements orbit through a torque-transmitting load zone that extends over an arc, and a free-running zone. On entering the load zone the wedge elements are coupled, that is the force-transmitting elements of the ring and the complementary force-transmitting elements of the wedge body engage one another in force-transmitting contact since the coupling elements pivot about their integral axes that preferably extend parallel to the pivot axis of the ring and of the center wheel. This force-transmitting contact is maintained through the entire load zone. When moving from the load zone to the free-running zone the wedge bodies are pivoted back to disconnect the force-transmitting formations. Each coupling element has an axially projecting force-transmitting pin shiftable in a respective one of the radial guides of the center wheel and transferring force during movement along the load zone to the center wheel. This so-called one-sided force transmission has the advantage that it simplifies the construction of the transmission.

The eccentricity of the center wheel and ring changes transmission ratio. The force-transmitting pins move as the transmission ratio is changed in the radial guides, that can be grooves or radially extending surfaces of pivotal wedge jaws that are pivotal toward one another once the transmission ratio is set to fix the desired position of the force-transmitting pins. The radial guides can be straight or slightly curved.

According to the invention the geometry of the coupling elements, the groove and the force-transmitting formation of the gear as well as the center wheel with its guides and the spacing of the gear to the center wheel are selected such that on moving through the force-transmitting zone the forces between the coupling element and the center wheel force or urge the parts together with a coupling force creating a torque holding the coupling element parallel to the gear and the center wheel and greater than the canting torque that is produced by the spacing between the effective plane of force transmission from the gear to the coupling elements on one side and the effective plane of the force transmission from the coupling elements to the center wheel on the other side. Preferably the force-transmitting formations of the ring and of the coupling element have the maximum number of teeth along their edges in order to increase the shifting precision that is determined by the tooth pitch. With a given circumference of the ring, the teeth are smaller when more of them are used. Small teeth have of course only small contact surfaces. Since the surface pressure of the teeth is limited by what the material can bear, under some circumstances the amount of torque that can be transmitted is very limited. For this reason each coupling element has unlike the standard pawls in free-running clutches a contact face with force-transmitting formations constituted by a number of teeth, which teeth mesh with the force-transmitting teeth of the ring. To increase the amount of transmissible angular force the wedge elements are constructed such that angular forces transmitted through the couplings element produce a rotation moment M1 that is always bigger than the rotation moment M2 produced by tooth-flank forces and tending to demesh them. In addition the transmissible torque is increased in that the friction at the forcibly pressed together contact faces works along with the components of the tooth forces in the angular direction.

With the selected one-sided force transmission from the coupling elements to the center wheel the effective lines of the incoming and outgoing forces lie in respective planes spaced apart by le. As a result of the existing equilibrium the incoming force Fₑᵢₙ and outgoing force Fₐᵤₛ are the same and opposite, that is they satisfy the equation Fₑᵢₙ=Fₐᵤₛ. The coupling element is subjected to the canting moment Mₖᵢₚₚ=le×Fₐᵤₛ, inhibiting rotation of the coupling element out of a position parallel to the plane of the ring and center wheel. The geometry of the wedge body is selected such that the rotation moment M1=Fₑᵢₙ×le initiates a pressing force in the teeth that leads to a stabilizing moment M_{S} that is larger than the canting moment Mₖᵢₚₚ.

The described solution can be put into practice for all practical and imaginable load conditions of the transmission since with the selected geometry of the transmission all the forces that lead to the above-defined moments are proportional to the applied torque. The selectable geometric parameters are in particular the tooth angle of the teeth, the height of the teeth, the mechanically effective width of the teeth, the mechanically effective length of the force-transmitting pin, the radius of curvature of the ring, the diameter or the length of the slide edge of the wedge element on the ring, the spacing between the ring and the center disk, the effective wedge angle of the wedge element, and the coefficient of friction of the teeth. The stability that is the goal of the transmission can also be ensured when the design of the transmission not only takes into account the forces applied to the ring and center wheel, but also the forces effective perpendicular thereto that have torques or lever effects as a result of the relative orientations of the wedge elements.

Preferred embodiments of the invention are described in the dependent claims.

Thus preferably the effective width of the force-transmitting formations when decoupled is at least as big as the sum of the mechanically effective length of the force-transmitting pin and the spacing, that is the gap, between the ring and the center wheel. This essential requirement is based on the fact that the force distribution on the various surfaces under actual conditions is generally axially and the parts have no significant elasticity, so that the stabilizing influence of friction on the surfaces of the teeth, which extend parallel to the plane of the rim surfaces of the ring, is not taken into account.

Preferably contact surfaces in the ring that serve to guide the coupling elements and exert the frictional forces, are so shaped and oriented that the effective line of the resultant of all frictional forces is then further (or nearer) from the center of the ring than the effective line of the resulting force between the coupling element and the center wheel when the effective line of the tooth forces is also further (or closer) from the center of the ring than the effective line between the coupling element and the center wheel. Even this feature serves to avoid canting of the wedge element in directions other than the pivot direction for coupling and decoupling.

In a further embodiment the coupling elements are not or not only guided in an annular groove but instead or also are braced directly radially by the force-transmitting pin on the run-on disk or a roller is fitted to the force-transmitting pin that itself rides on the run-on disk. In addition in a particular variant there is a run-on disk on the ring that lies below the force-transmitting disk. In this case the force-transmitting disk extends from the coupling element to the center wheel through the annular slot that the two run-on disks form. In this case the annular groove in the ring is not strictly necessary and can be eliminated. The advantage of this solution is not only in its compact construction but also in the limited canting moment when sliding, since the guiding forces in contact with the run-on disk(s) are spaced quite a bit from the guide forces in the center wheel and thus the length of the effective lever arm is reduced.

According to a further embodiment of the invention the coupling elements each have an axial bore that is above and parallel to the pivot axis of the respective coupling element and parallel to and above the pin axis and that holds a compression spring that bears at one side on a run-on disk so that the coupling element is axially guided and so that all or at least most of the frictional forces engage outward of the force-transmitting pin so that on direction change the applied angular forces produce a moment helping the coupling or decoupling torque. This spring thus serves to elastically bias the wedge element against lateral canting when it is sliding.

According to a further embodiment of the invention the ring has another ring surface parallel to a surface of the force-transmitting formation, a spring having one end bearing on it and another free end bearing elastically on the coupling element, an angle (α) between the connecting line of the contact point on the surface and the contact point of the spring on the coupling element and the radial line through the contact point of the spring on the coupling element complying with the formula tan(α)≦μ, where μ is the coefficient of friction between the spring (19) and the surface (18).

In order to solidly lock the coupling elements when transitioning from the free-running zone to the force-transmitting zone, the torque effective on the coupling elements must be greater than the torque resulting from the product of the friction and the spacing a, this spacing a being the distance to the first force-transmitting element coming into engagement with the force-transmitting formation of the ring from the wedge-element axis.

To further optimize the functioning of the coupling elements the center of all masses that rotate on coupling of the coupling element lie generally on the pivot axis about which the coupling element rotates when coupling (or decoupling).

According to a further embodiment of the invention the force-transmitting formation is formed with angled teeth. The fit of the coupling elements in the peripheral groove of the ring and of the force-transmitting pin in the radial guides of the center wheel is as tight as possible in order to ensure the parallel positioning of the coupling elements and also to prevent canting with wedging and self-locking.

In order to provide optimal setting accuracy, the force-transmitting pin has a ring that is eccentric to the force-transmitting pin. The torque-producing angular force is applied by the ring to the coupling element, with which the ring or the rings in the radial grooves of the center wheel are entrained angularly so that the rings roll instead of slide. The same is true for sleeves mounted on the ends of the force-transmitting pins that roll in the radial grooves of the center wheel or on the annular groove of the ring. The angular force on the contact location between the radial groove of the center wheel and this sleeve brings to be due to the eccentric offset between the force-transmitting point on one side and the ring with the sleeve on the other side a rotation moment that turns the coupling element according to the direction of the force into or out of mesh. Since the eccentric offset can be set if desired very small and the spacing of the tooth upper surface from the coupling element can correspondingly be much larger, a lever-arm relationship is possible that with small relative movements of the contact points in the radial groove causes bigger movements in the teeth of the coupling element. The useless dead travel that impairs the desired or required accuracy, is thus quite small; the shifting accuracy can be set to the tooth pitch. In fact after engagement or coupling of the coupling element there is no more slide or roller movement in the teeth, that is all the teeth are active and carry load. The dimensioning of the tooth-foot load depends thus not on the size of the individual teeth, but only on the width of the coupling elements.

Further embodiments of the invention are described with reference to the drawing. Therein:

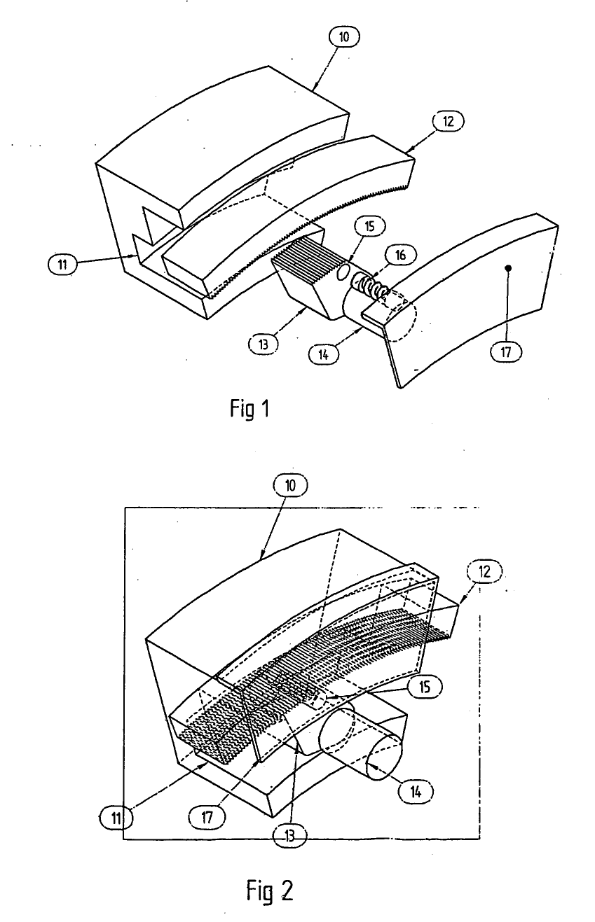

FIG. 1 is an exploded view of the ring with the peripheral groove and a gear, a wedge element, and a run-on disk;

FIG. 2 shows these parts in a transparent view without the axial explosion offset;

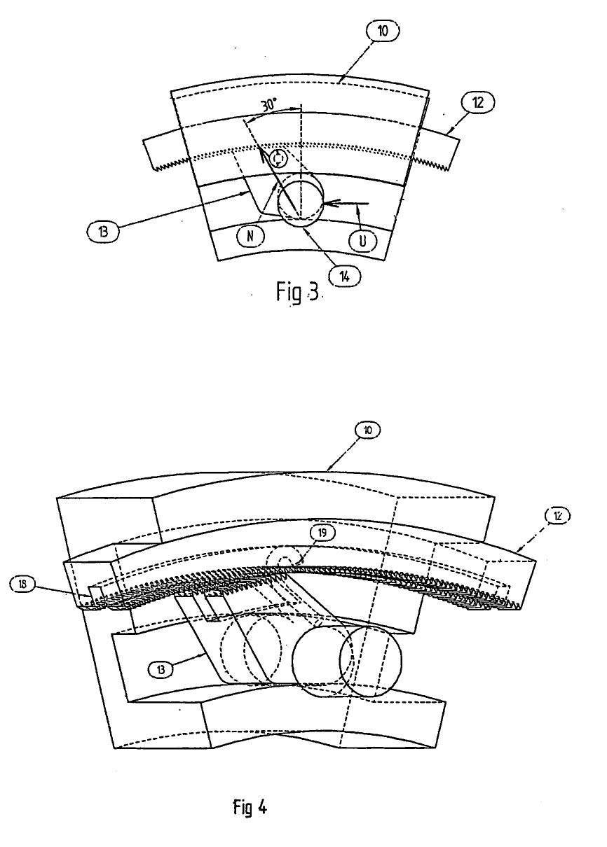

FIG. 3 is a side transparent view of the ring and a coupling element in force-transmitting position;

FIG. 4 is a perspective transparent view of the arrangement of FIGS. 2 or 3 with an additional spring-biasing of is the coupling element;

FIG. 5 is a side view of the structure of FIG. 4;

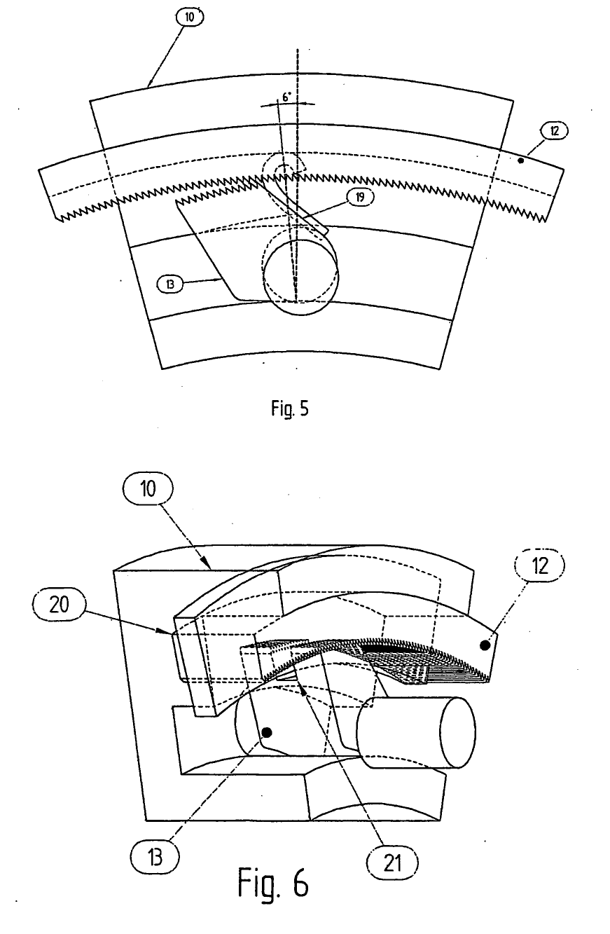

FIG. 6 is a perspective view like FIGS. 2 and 3 with an additional guide for the planar orientation of the coupling element;

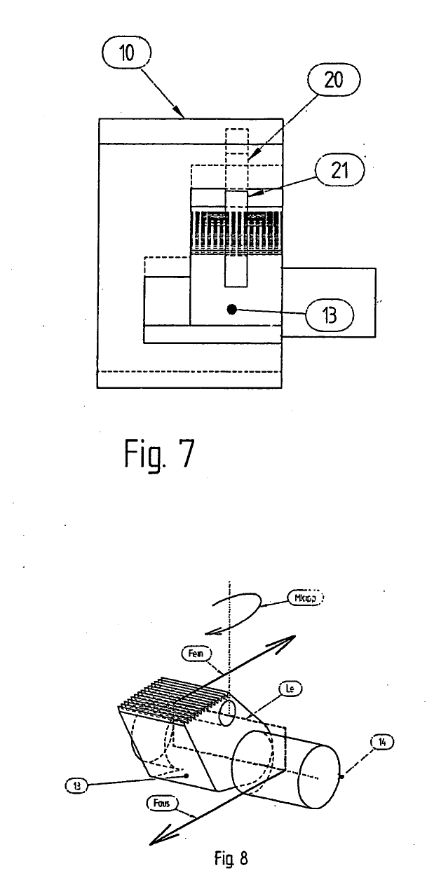

FIG. 7 is a side view of the structure of FIG. 6;

FIG. 8 is a transparent view of a coupling element with a force-transmitting pin and also showing the forces and torques effective during coupling; and

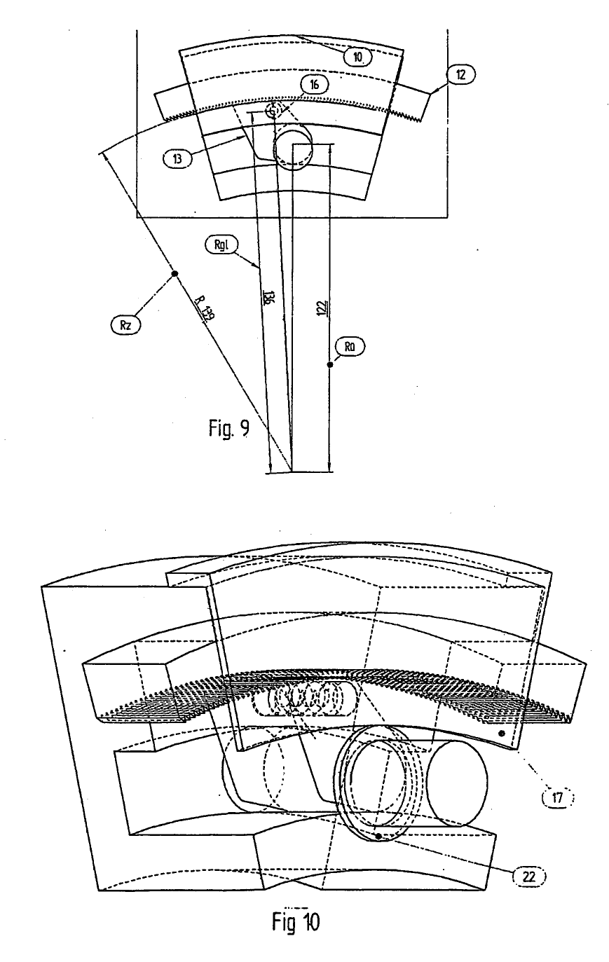

FIG. 9 is a schematic side view of a coupling element and a part of a ring also showing frictional forces;

FIG. 10 is a perspective view of a wedge element and a part of the ring with a roller 22 on the force-transmitting pin that engages the run-on disk.

Basically the transmission corresponds to that shown in EP 0,708,896, EP 1,003,984, and DE 199 53 643.

The satellite transmission has a ring 10 with a peripheral groove 11 in which coupling elements 14 formed as wedge bodies ride. These coupling elements move in a circular path in the groove through an arcuate torque-transmitting zone and an arcuate free-running zone, pivoting of the coupling elements creating contact with the groove that as is known in the art either results in sliding or as shown in FIG. 1 in force transmission, so that the applied torque is transmitted to the center wheel. To this end the coupling elements each have an axially projecting force-transmitting pin 14 that, as also known in the art, engages in a respective radially extending guide groove of the center wheel. Instead of these radial guides in an unillustrated center wheel pivotal wedge jaws can be provided on the center wheel that swing apart to grip the force-transmitting pins and thus fix them radially on the center wheel. The position—concentric or eccentric—of the center wheel with respect to the ring determines the transmission ratio. The ring and the center wheel are parallel to each other.

FIG. 1 shows in exploded view with axial offset a segment of the ring 10 with the groove 11 as well as force-transmitting formations 12, which in this case are formed as a ring gear. A face of the wedge element 13 turned toward the gear 12 has complementary teeth. Preferably there are several parallel rows of teeth that have an axial dimension that in this case is greater than that of the force-transmitting formations of the coupling element. The arrangement in FIG. 1 is one sided, since force is transmitted to the center wheel only on one side, that is via the force-transmitting pin 14. The coupling element 13 has an axial bore 15 that holds a spring 16 that bears in one direction on the ring and in the other end on the run-on disk 17 so that the coupling element 13 is axially guided and at the same time all or at least most of the frictional forces are effective above the force-transmitting pins 14 so that on direction change the applied angular force produces a coupling moment on entering the torque-transmitting zone and a decoupling moment on leaving the torque-transmitting zone. The arrangement of these parts in assembled condition is shown in particular in FIG. 2.

FIG. 3 shows in a side view the position of the coupling element 13 when coupled, where the gear 12 is in force-transmitting engagement with the teeth of the coupling element 13, created by pivoting of the coupling element 13 on entry into the torque-transmitting zone. When the coupling element 13 swings back on leaving the torque-transmitting zone and entering the free-running zone, the parts are disconnected from each other. In the force-transmitting position (from the ring 10 to the unillustrated center wheel) an angular force U is applied to the force-transmitting pin 14 of the coupling element 13. The geometry of the coupling formation in this case is such that at the illustrated angle of 30° there is in the center of the teeth a normal force N by means of which the teeth of the coupling element 13 are pushed into the teeth of the ring gear 12 and thus are capable of transmitting considerable angular force through small parts without the interengaged gear 12 and the coupling element 13 jumping apart. With steeper teeth and a smaller angle than the illustrated one of 30° this normal force is even greater.

In a further embodiment according to FIG. 4 a peripheral groove 18 is formed centrally in the gear 12 so as to subdivide the gear 12 into two toothed rings. The coupling element 13 is similarly split at its teeth. A spring 19 engages into this groove 18, here a wire spring with an upper bent-over end and an opposite inner end fixed on the wedge element 13. The spring 19 rides in the groove 18 and is guided by it. The coupling element 13 and its spring 19 are set such that in the arrangement of FIG. 5 the contact point of the spring 19 on the floor of the groove 18 forms with the contact point of the wedge element 13 in the groove of the ring 10 an angle α that in this arrangement is 6 (the other leg being formed by a radial line). The tangent of this angle (here 6°) is smaller than the relationship of the normal force to the friction, that is smaller than the coefficient of friction μ. For 6° there is: tangent 6°=0.11<μ. Thus without external control, simple spring action lifts the coupling element 13 in the free-running zone from force-transmitting contact (with the teeth) and in the torque-transmitting zone automatically establishes the force-transmitting connection.

In order to avoid a situation in which the teeth are only partially intermeshed, in a further embodiment the tooth shape, that is the shape of the force-transmitting formations, is selected such that the sum of the moments that are produced by friction during sliding of the teeth and that are effective opposite to the movement during coupling by swinging of the coupling element, is always smaller than the moment that serves for coupling or locking.

FIG. 6 shows an embodiment of the transmission where the parallel position of the clamping element 13 is established in that it has a groove-shaped slot 21 in which a guide ridge 20 engages that projects centrally from the gear 12 and that subdivides the gear 12 axially into two gear halves. As in FIG. 1, the wedge element 13 can also have a bore for holding a spring 16 that is braced on one end on the guide ridge 20 (if necessary left and right).

As shown in FIG. 8, diametrally opposed forces Fₑᵢₙ and F^{aus} bear on the coupling element 13, ideally centrally of the coupling formations and centrally of the force-transmitting pin 14. This force balancing is achieved with the tightest possible tolerances equal to zero along with the requirement that the coupling element be a rigid body, when meshing of the teeth prevents a canting of the coupling element in spite of the torque moment Mₖᵢₚₚ.

As shown in FIG. 9 the gear has a radius Rz and the force-transmitting pin 14 orbits with its pivot axis on a radius Run. The axially effective spring 16 from FIG. 1 slides on a radius R_{gl} on which the friction of the plane-parallel guiding of the wedge element 13 engages, resulting from the sliding action of the wedge element. Positive latching torque is produced by satisfying the equation R_{gl}>_{Run}.

All of the parts that pass the coupling elements 13 are guided at one end in the ring 10, in the teeth 12, and in the radial grooves of the center wheel. In order to make this linear guiding as loss-free as possible, the interfit tolerances must be tight enough to ensure parallel positioning of the wedge element or elements, on the other hand it is essential to prevent canting that would produce wedging or self-locking. To this end the fit is such that, when passing, the coupling elements 13 are guided by springs on the ring so that there is no wedging action, but instead all the tipping torque Mₖᵢₚₚ, which is caused by the one-sided force deflection, is resisted by spring force. The spring characteristic and the spring prestress thus prevent any deflection allowing contact of any hard parts, in particular the nested curved peripheral parts with resultant wedging. In the coupled condition of the coupling formations on the other hand the stabilizing force of the meshing teeth is dominant and holds the wedge body guided in the groove and its force-transmitting pin parallel in the center wheel without canting.

In a further embodiment the teeth can be angled so that the wedge element 13 when meshing is pushed into the floor of the groove of the ring 10 and is thus stabilized against canting.

In use each coupling element is acted on by a number of forces, as for example mass forces from intermittent phases in rotation, centrifugal forces, Coriolis forces, and frictional forces at the various contact surfaces. These forces are effective along different lines and in different planes so that the moments together ensure the engagement and disengagement of the coupling elements during rotation and their parallel positioning.

When the coupling elements are free running these forces can be used positively, because the coupling action should and must be simultaneous at any location along the circumference and by all elements. To this end for example permanently applied forces can be used in order to hold the pawls or wedge bodies in constant contact in guide pockets or clamp rings. In addition it is possible to use springs that ensure such permanent contact.

With the above-described satellite transmission on the other hand the described permanently effective forces and torques around the entire periphery are disturbance factors since at any given time during force transmission only one of the coupling elements is actually transmitting force, while the other coupling elements are decoupled and in their free-running mode. For a smooth and friction-free operation with a satellite transmission only those forces and torques are used that press the coupling elements in their force-transmitting zones into the teeth and that raise them therefrom in their free-running zones. When moving from the force-transmitting zone to the free-running zone the force effective on the force-transmitting pin reverses, since the force-transmitting pin on moving along the force-transmitting zone transmits force and on running through the free-running zone is only entrained or shifted by the center wheel. In order to rotate the coupling elements so as to couple and decouple it, as a result only those forces are used that form together with the force on the pin a force pair that causes coupling on entry into the force-transmitting zone and decoupling on leaving the force-transmitting one or reinforces this movement.

To suppress unwanted moments the coupling elements are balanced such that the pivot axis of the latching movement is ideally through or at least near the center of all the masses moving during coupling. In addition all contacts that are geometrically or physically necessary during the relative movement of the coupling element and the gear for guiding and the associated frictional forces are set such that they produce relative to the effective line of the forces on the force-transmitting pin positive latching moments. This is achieved in part by selection of the radii according to FIG. 9.

A further advantage is provided by the spring 16 that elastically suppresses lateral canting of the coupling elements when sliding, so that a generally constant (friction) force is produced that during coupling and decoupling positively reinforces the pivoting action of the coupling elements.

The already described spring 19 is effective in the same manner on the annular surface 18.

As shown in FIG. 10, preferably there is a roller 22 on the force-transmitting pin that rides on the run-on disk 17 so that the coupling element is guided on the rim of the gear with the least possible likelihood of canting.

1. A stepless transmission with a ring (10) having a force-transmitting formation (12), preferably teeth, and a peripheral groove (11), and concentrically or eccentrically positionable relative thereto a center wheel with radial guides, and with at least two coupling elements (13) that each ride at one end in the peripheral groove (11) and that have force-transmitting formations complementary to the force-transmitting formation (12) and that each at the other end have a force-transmitting pin (14) projecting axially into and shiftable in a respective one of the radial guides of the center wheel, each coupling element (13) moving on orbiting in the peripheral groove (11) of the gear (10) through a force-transmitting zone in which the coupling element (13) is engaged with the force-transmitting formations (12) of the gear (10) and that otherwise is in a free-running zone in which it is disconnected (decoupled) and where by varying the eccentricity of the center wheel and ring the transmission ratio is changeable,
characterized in that
the geometry of the coupling elements (13), the groove and the force-transmitting formation (12) of the gear as well as the center wheel with its guides and the spacing of the gear to the center wheel are selected such that on moving through the force-transmitting zone the forces between the coupling element (13) and the center wheel force or urge the parts together with a coupling force creating a torque holding the coupling element (13) parallel to the gear and the center wheel and greater than the canting torque that is produced by the spacing between the effective plane of force transmission from the gear to the coupling elements on one side and the effective plane of the force transmission from the coupling elements to the center wheel on the other side.

2. The transmission according to claim 1, characterized in that the effective width of the force-transmitting formations when decoupled is at least as big as the sum of the mechanically effective length of the force-transmitting pin and the spacing, that is the gap between the ring and the center wheel.

3. The transmission according to claim 1, characterized in that contact surfaces in the ring (10) that serve to guide the coupling elements (13) and exert the frictional forces, are so shaped and oriented that the effective line of the resultant of all frictional forces is then further (or nearer) from the center of the ring than the effective line of the resulting force between the coupling element and the center wheel when the effective line of the tooth forces is also further (or closer) from the center of the ring than the effective line between the coupling element and the center wheel.

4. The transmission according to claim 1, characterized in that the coupling elements each have an axial bore that is above and parallel to the pivot axis of the respective coupling element and parallel to and above the pin axis and that holds a compression spring (16) that bears at one side on a guide wall (17) (run-on disk), that extends parallel to the plane of the ring, and of the center wheel, and that on the other end bears on a nearly parallel guide wall of the peripheral groove (11) or that there is such a spring in the coupling element between the guide wall and the peripheral groove.

5. The transmission according to claim 1, characterized in that the ring (10) has another ring surface (18) parallel to a surface of the force-transmitting formation (12), a spring (19) having one end bearing on it and another free end bearing elastically on the coupling element, an angle (α) between the connecting line of the contact point (19) on the surface (18) and the contact point of the spring on the coupling element and the radial line through the contact point of the spring on the coupling element complying with the formula tan(α)≦μ, where μ is the coefficient of friction between the spring (19) and the surface (18).

6. The transmission according to claim 1, characterized in that the torque of the coupling elements (13) is greater when moving from the free-running zone into the force-transmitting zone than torque (Mr) resulting from the product of the friction (R) and the spacing (a) between the first force-transmitting element coming into engagement with the force-transmitting formation (12) of the ring from the wedge-element axis.

7. The transmission according to claim 1, characterized in that the run-on disk (17) bears directly or via a roller (22) with the force-transmitting pin (11) so that the coupling element is guided by this contact on the rim of the ring with the least possible canting effect.

8. The transmission according to claim 7, characterized in that a second run-on disk is set on the inner radius and forms with the first run-on disk (17) an annular slot through which the force-transmitting pin (14) projects out of the coupling element and thus or via a roller (29) indirectly serves for guiding the pin (14) on the periphery with the smallest possible canting action.

9. The transmission according to claim 1, characterized in that the center of all masses that rotate on coupling of the coupling element (13) lie generally on the pivot axis about which the coupling element rotates when coupling.

10. The transmission according to claim 1, characterized in that the force-transmitting formation (12) is formed with angled teeth.

11. The transmission according to claim 1, characterized in that the fit of the coupling elements (13) in the peripheral groove (11) of the ring (10) and of the force-transmitting pin (14) in the radial guides of the center wheel is as tight as possible.

12. The transmission according to claim 1, characterized in that the coupling element has a groove in the force-transmitting formations and in which a disk-shaped guide of the ring can slide.

13. The transmission according to claim 1, characterized in that a ring is employed with a preferably round shape eccentric to the force-transmitting pin (14) so that the force that is exerted by the ring (10) on this ring produces rotation of the coupling element (13) about the longitudinal axis of the pin (15).

14. The transmission according to claim 13, characterized in that sleeves are mounted on the rings and/or over the end of the force-transmitting pins (14) that roll instead of slide in the radial grooves of the center wheel and/or in the peripheral groove (11) roll.

15. The transmission according to claim 13, characterized in that the ring and/or the sleeve and/or the force-transmitting pin (14) have a collar that when loaded holds the force-transmitting pin (14) and the coupling element parallel to the ring (10).

16. The transmission according to claim 1, characterized in that by a guide element, preferably a guide pin, ana air or liquid guide or a magnet for externally controlling the movements of the coupling elements.
